(19) United States
(12) Patent Application Publication
(10) Pub. No.: US 2014/0254796 A1
(43) Pub. Date: Sep. 11, 2014

(54) METHOD AND APPARATUS FOR GENERATING AND/OR PROCESSING 2D BARCODE

(71) Applicant: THE CHINESE UNIVERSITY OF HONG KONG, Hong Kong (CN)

(72) Inventors: Chak Man Li, Hong Kong (CN); Wing Cheong Lau, Hong Kong (CN)

(73) Assignee: THE CHINESE UNIVERSITY OF HONG KONG, Hong Kong (CN)

(21) Appl. No.: 13/790,536

(22) Filed: Mar. 8, 2013

(51) Int. Cl. H04L 9/32

(52) U.S. Cl. CPC H04L 9/3247
USPC 380/246

(57) ABSTRACT

A computer-complemented method for generating a 2D barcode, including retrieving a predetermined private key, a predetermined digital signature method and an issuer identity of a 2D barcode; generating a signature for at least one data with the retrieved private key in accordance with the retrieved digital signature method; inserting the at least one printable data together with the generated signature and the retrieved issuer identity into a self-contained data unit; and creating a barcode image containing the self-contained data unit.

### TECHNICAL FIELD

The present application relates to a method for generating a 2D barcode, a method for generating a document with the 2D barcode.

### BACKGROUND

2D barcode, especially QR code, has an increasing usage worldwide such as advertisements, train tickets, airplane boarding pass, etc. However, people cannot verify the creator/generator and contents of a 2D barcode. Attackers may use 2D barcode to distribute URL of malicious website, phishing social webpage or malware mobile application. 2D barcode scanning also provides a new attack vector to the scanner and applications in Smart phones (for example). The key problem behind thereof is the lack of authentication on barcode.

### SUMMARY

One aspect provides a computer-complemented method for generating a 2D barcode. The method may comprise a step of retrieving a private key, a digital signature method and an issuer identity of a 2D barcode. A signature is then generated with the retrieved private key in accordance with the retrieved digital signature method. At least one data together with the generated signature and the issuer identity may be into a self-contained data unit. And then a barcode image containing the self-contained data unit is created.

Another aspect provides a computer-complemented method for verifying a 2D barcode. According to this method, a packaged data unit is extracted from the barcode, and then a copy of packaged data without a digital signature and a certificate, a digital signature, an issuer identity of the barcode, and a digital signing method will be retrieved from the extracted data unit. The method further creates a digest on the packaged data unit according to the retrieved digital signing method, and selects, according to the retrieved issuer identity, a suitable digital certificate including a public key for verifying the barcode. The retrieved digital signature will be decrypted with the selected suitable public key, and then it is determined if the decrypted signature is same as the digest, if yes, data in packaged data unit is verified.

Another aspect provides a computer-complemented method for creating a document with authentication features, and a computer-complemented method for reading the created document.

### BRIEF DESCRIPTION OF THE DRAWINGS

Exemplary non-limiting embodiments of the invention are described below with reference to the attached figures. The drawings are illustrative and generally not to an exact scale.

FIG. 1 is a schematic diagram for illustrating a system for authenticating a 2D barcode consistent with some disclosed embodiments.

FIG. 2 is a schematic diagram illustrating apparatus for creating/reading a 2D barcode, consistent with some disclosed embodiments.

FIG. 3 is a block diagram showing an authentication module executed by the apparatus, consistent with some disclosed embodiments.

FIG. 4 illustrates a schematic Scenario flow of a barcode creation, consistent with some disclosed embodiments.

FIG. 5 is a flowchart illustrating a method for crating a document, consistent with some disclosed embodiments.

FIG. 6 is a block diagram showing a verification module executed by the apparatus, consistent with some disclosed embodiments.

FIG. 7 illustrates a schematic Scenario flow of a barcode reading, consistent with some disclosed embodiments.

FIG. 8 is a flowchart illustrating a method for reading a barcode in reference to FIG. 7, consistent with some disclosed embodiments.

FIG. 9 illustrates the architecture of system of authentication and integrity checking on a printed document as well as data flow of this system.

FIG. 10 illustrates the flow of document creation as well as barcode scanning according to some embodiments.

### DETAILED DESCRIPTION

Reference will now be made in detail to exemplary embodiments, examples of which are illustrated in the accompanying drawings. When appropriate, the same reference numbers are used throughout the drawings to refer to the same or like parts.

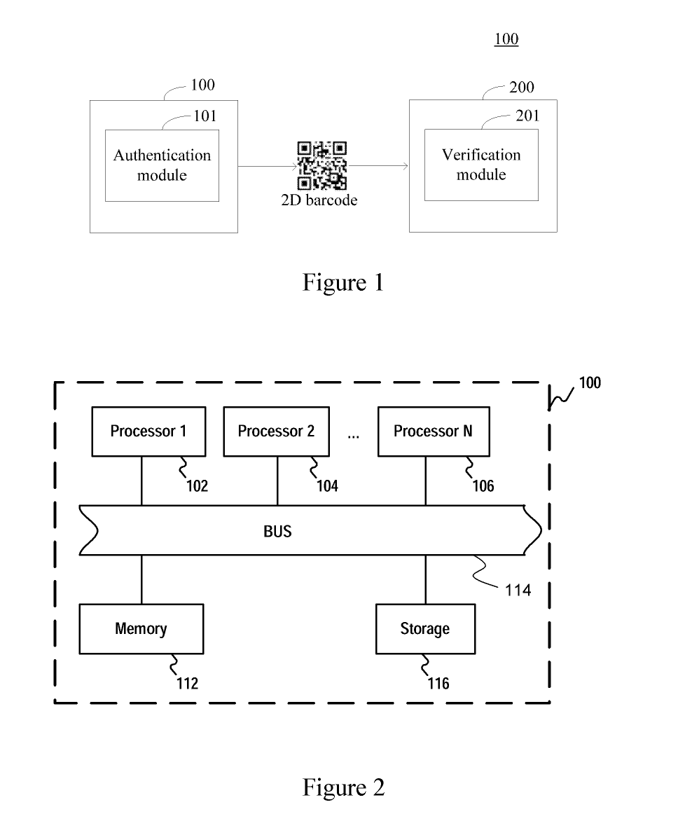

FIG. 1 is a schematic diagram for illustrating a system 1000 for authenticating a 2D barcode consistent with some disclosed embodiments. As shown in FIG. 1, the system 1000 may comprise an apparatus 100 for creating a 2D barcode (creator) and an apparatus 200 for reading the 2D barcode (scanner). The apparatus 100 and 200 may be mobile devices like Smart phones, or a general purpose computer, a computer cluster, a mainstream computer, a computing device with graphical interface, or a computer network comprising a group of computers operating in a centralized or distributed fashion. The apparatus 100 and 200 may have the same schematic hardware architecture. FIG. 2 is a schematic diagram illustrating apparatus 100/200 for creating/reading a 2D barcode, consistent with some disclosed embodiments.

As shown in FIG. 2, the apparatus 100/200 (creator/scanner) may include one or more processors (processors 102, 104, 106 etc.), a memory 112, a storage device 116, a bus 114 to facilitate information exchange among various components of apparatus 100. Processors 102-106 may include any suitable information processing devices to execute sequences of computer program instructions so as to perform various methods that will be explained in greater detail below.

Memory 112 can include, among other things, a random access memory (“RAM”) and a read-only memory (“ROM”). Computer program instructions can be stored, accessed, and read from memory 112 for execution by one or more of processors 102-106. In some embodiments, the storage device 116 may be provided to store software applications that are executable by one or more processors 102-106. Storage device 116 may include one or more magnetic storage media such as hard drive disks; one or more optical storage media such as computer disks (CDs), CD-Rs, CD±RWs, DVDs, DVD±Rs, DVD±RWs, HD-DVDs, Blu-ray DVDs; one or more semiconductor storage media such as flash drives, SD cards, memory sticks; or any other suitable computer readable media. In some embodiments, the apparatus 100/200 may not include the above mentioned storage device but can communicate with an external storage device.

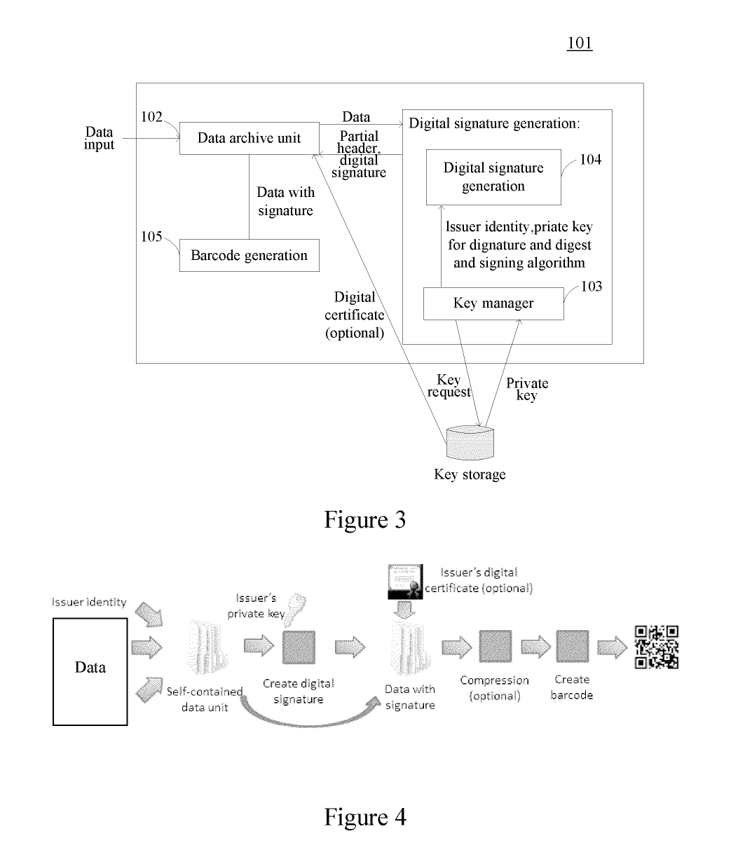

Embodiments consistent with the present disclosure provide methods, systems, apparatuses, and computer readable media. FIG. 3 is a block diagram showing an authentication module 101 executed by the apparatus 100, consistent with some disclosed embodiments. Referring to FIG. 3, the authentication module 101 may comprise a data archive module 102, a key manager module 103. The key manager module 103 is configured to prepare an issuer identity of the barcode, and to retrieve a private key and digital signature method according to the issuer identity. The data archive module 102 is configured to insert at least one data and the prepared issuer identity into a self-contained data unit.

In particular, the self-contained data unit may comprises the following fields in some embodiments:

1) Format header: A text header that describes the type of this data unit.

2) Issuer Identity: Identity of a barcode issuer or of issuer of certificate included in text format. Scanners 200 may use this text value to select suitable digital certificate to verify the barcode, which will be discussed latter.

3) Data: Above mentioned at least one data, which can be text or any binary data. In addition, there are optionally encoding method, file name and compression method in this field. Optionally, programming instructions (such as digitally-signed device-driver-code), a self-describing programming interface, like short-range radio universal remote control on home appliance; self-describing service-access interface, e.g. a data that tell the scanner (or its applications) how to use/access web-services or the like can be stored in the field of Data or other dedicated field in the self-contained data unit, such that these data can be delivered to the scanner upon a verification (as discussed latter) for the scanner to execute the corresponding application.

4) Signature method: Text data to indicate the method of creating digital signature and digest.

6) Digital signature: Digital signature to be inserted.

7) (Optional) Digital certificate: digital certificate of the issuer.

In some applications, some data type may not be supported in the apparatus 100. For example, if authenticated 2D barcode system 1000 is used as address proof, data input is text only. Then the apparatus 100 only needs to support text data. The self-contained data unit must be supported in both apparatus 100 and apparatus 200 to make the system 1000 works. It should support multiple inputs in expected formats as well as digital signature and is self-contained. Other possible data units include JSON object, .zip and .tar file.

As shown, the authentication module 101 may further comprise a digital signature generation module 104 and a barcode generation module 105. The digital signature generation module 104 is configured to generate a signature with the retrieved private key in accordance with the retrieved digital signature method, wherein the data archive module inserts the generated signature into the self-contained data unit. The barcode generation module 105 is configured to create a barcode image containing the self-contained data unit after digital signature is inserted.

Optionally, the authentication module 101 may further comprise a compression module (not shown) configured to compress the self-contained data unit before it is inputted into the barcode generation module 105.

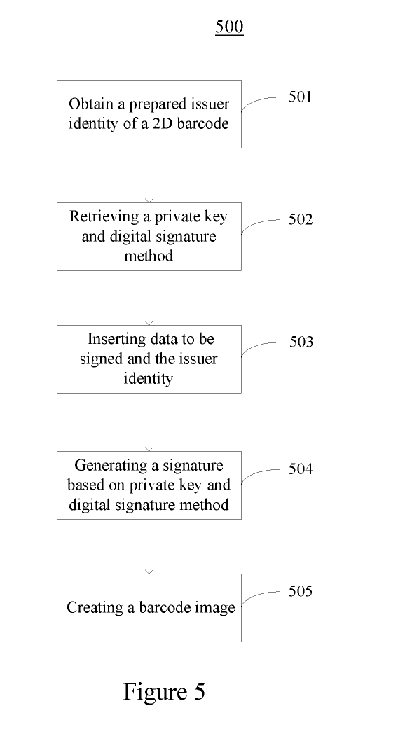

FIG. 4 illustrates a schematic Scenario flow of a barcode creation, consistent with some disclosed embodiments. FIG. 5 is a flowchart illustrating a method for crating a document in reference with FIG. 4, consistent with some disclosed embodiments. In FIG. 5, process 500 comprises a series of steps that may be performed by the authentication module 101 executed by one or more of processors 102-106 of apparatus 100 to implement a data processing operation initiated by a user.

In step 501, the key manager module 103 is configured to obtain a prepared issuer identity of a 2D barcode according to user selection. For example, the issuer identity may be saved in a list stored in the key manager module 103. Each identity on the list is pre-inputted by the user. In some embodiments, the identity may be email address or company name. In some embodiments, when an issuer identity is inputted to key manager for the first time, a unique private-public key pair is created for that identity. Then the user needs to apply for a digital certificate from a service provider. The applied digital certificate will be saved in a key storage that may be internal or external to the apparatus 100 and a database of the service provider after issuing. There may be more than one issuer identity in the key manager module 103. Which identity is used to create Authenticated 2D barcode depends on the user preference. Also, the user may choose to input the user identity, the assigned key pair and digital certificate into the key manager module 103 and the key storage altogether. In addition, the available digital signature methods for an issuer identity may be decided based on the associated key pair by the service provider when issuing the digital certificate. For example, the digital signature methods for an issuer identity are listed inside the identity's digital certificate.

In Step 502, the key manager module 103 retrieves a private key and digital signature method according to the issuer identity selected by user. In particular, for each user identity, the key manager module 103 reads the available digital signature methods from the digital certificate and selects one as a default digital signature method automatically. The criteria of selecting default digital signature method from the digital certificate depend on the specific application. User may also select other signature methods listed in the digital certificate as default before creating the Authenticated 2D barcode. However, the selected digital signature method for a user identity must be listed in that identity's digital certificate.

The retrieved digital signing method must be supported between creator (apparatus 100) and scanner (apparatus 200), and shall ensure that signature size should be short and verification should be fast, while security of signature should satisfy with the related standards like SP800-57. Other possible signing methods include RSA, DSA. Possible digest methods include SHA-1, etc.

In Step 503, the key manager module 103 sends obtained private key, issuer identity and digital signature method to digital signature generation module 104. Module 104 saves private key and forwards other data to the data archive unit module 102. The data archive module 102 inserts at least one data to be digitally signed and the issuer identity and digital signing method into the self-contained data unit. In some embodiments, the at least one data may include at least one printable data, or other executable programs and computer interface. The data can be digitally encrypted or not. Any text or binary data stated in MIME standard can be inputted as said data.

In Step 504, the data archive module 102 sends the self-contained data unit with the inserted data to the digital signature generation module 104. The digital signature generation module 104 uses the private key obtained in step 502 to generate a digital signature on the self-contained data unit by the signing method obtained in step 502. The process of creating digital signature follows the related standards. In some embodiments, ECDSA (Elliptic Curve Digital Signature Algorithm) with SHA-512 as digest method may be used. Private-public key pair, used in digital signing and verification (discussed later), has size 256 bits. Since how to generate the private-public key pair necessary for creating digital signature and the digital certificate belong to the conventional technical means, the detailed description thereof are omitted herein.

In Step 505, the data archive module 102 then inserts generated signature from the signature generation module 104 into the self-contained data unit, and then the barcode generation module 105 creates a barcode image containing the self-contained data unit after digital signature is inserted. In some embodiments, the barcode generation unit 105 may create barcode(s) according to standard of QR code. If size of data is larger than data limit of a QR code, data is divided into two or more QR codes, according to QR code standard. In implementation, the generated barcode must be capable of storing the data unit or support saving data in multiple barcodes. It can be in any format, black and white or color, as long as printable by regular printer. Possible barcode format includes HCCB, etc. The error correction level on barcode selected, if any, can be adjusted according to implementations.

Optionally, the data archive module 102 may get a digital certificate of the selected issuer identity, through the key manager module, from the key storage or the key manger module 103, and then add it into the self-contained data unit.

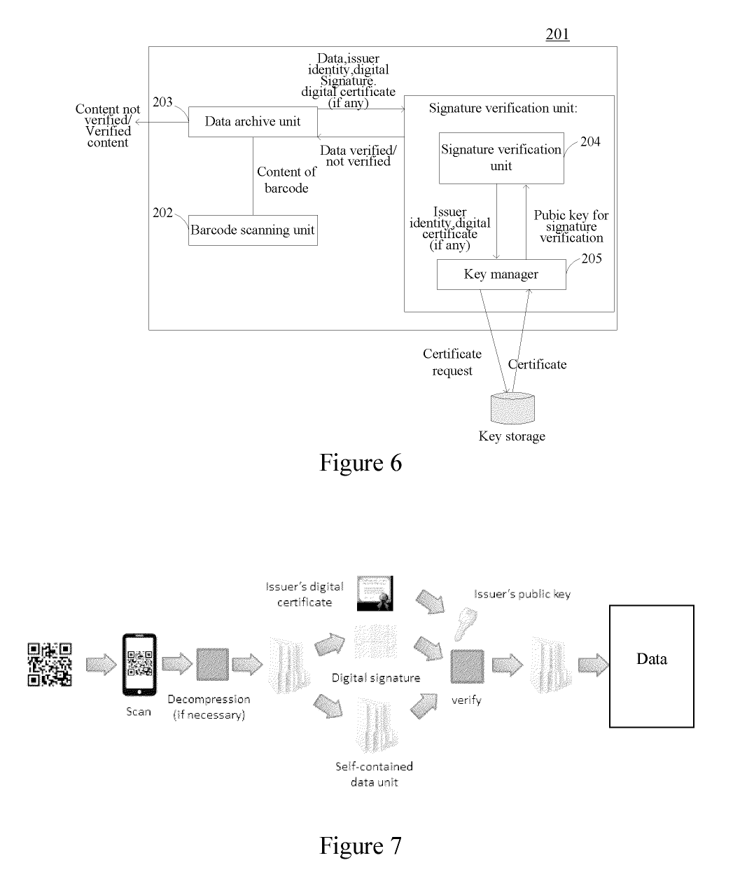

FIG. 6 is a block diagram showing a verification module 201 executed by the apparatus 200, consistent with some disclosed embodiments. Referring to FIG. 6, the verification module 201 may comprise a barcode scanning module 202, a data archive module 203 and a digital signature verification module 204 and a key manager module 205. The barcode scanning module 202 is configured to reads contents of a barcode. In some embodiments, the barcode scanning module 202 follows the related standards in QR code. The data archive module 203 may extract a packaged data unit from the barcode and retrieve a digital signature, a issuer identity of the barcode and at least one printable data, a digital signing method from the extracted data unit. The key manager module 205 may select a digital certificate according to the issuer identity retrieved by the data archive module 203, and the digital signature verification module 204 may verify if the data in packaged data is valid by digital signature and the public key included in the digital certificate.

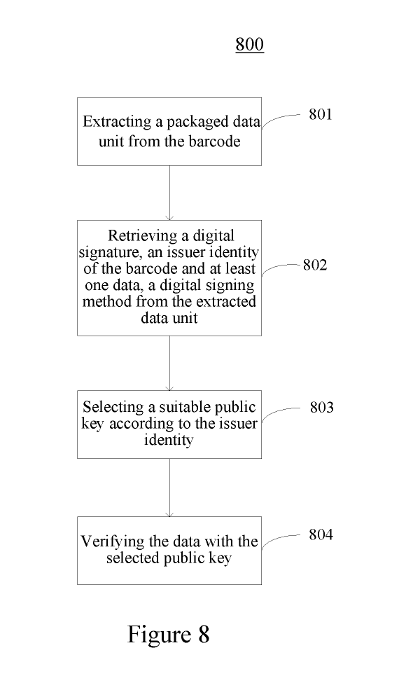

FIG. 7 illustrates a schematic Scenario flow of a barcode reading, consistent with some disclosed embodiments. FIG. 8 is a flowchart illustrating a method for reading a barcode in reference with FIG. 4, consistent with some disclosed embodiments. In FIG. 8, process 800 comprises a series of steps that may be performed by the verification module 201 executed by one or more of processors 102-106 of apparatus 100 to implement a data processing operation initiated by a user.

In Step 801, the barcode scanning module 202 locates and reads contents (in particular, a packaged data unit) of barcode from the input like camera or image, and returns the contents to the data archive module 203. In Step 802, the data archive module 203 gets the read contents of the barcode, and then extracts a packaged data unit from the barcode. The data archive module 203 further retrieves the digital signature, the issuer identity, the digital signing method, and the digital certificate (if any) and a copy of packaged data without the digital signature and the certificate from the extracted data unit and send them to the signature verification module 204.

In Step 803, the signature verification module 204 creates a digest on the packaged data unit without digital signature and certificate retrieved in Step 802, according to the method stated in digital signing method. In particular, the signature verification module 204 then sends the issuer identity and digital certificate (if any) to the key manager module 205, so that the key manager module 205 may, according to the issuer identity, select a suitable digital certificate including a public key for verifying the barcode, or digital certificate from barcode (if any), from the key storage which may be internal or external to the apparatus 200.

In some embodiments, if no digital certificate is obtained from the barcode. The public key from the suitable digital certificate is sent to module 204. Otherwise, the suitable digital certificate is used to verify the certificate from the barcode, according to given standard in public key infrastructure or pretty good privacy. If it is verified, the public key in certificate from barcode is sent to module 204.

In Step 804, the digital signature verification module 204 determines if the copy of packaged data without digital signature and certificate (if any) can be verified with the selected suitable digital public key, if yes, at least the issuer identity and the at least one data may be shown to a user. Specifically, the signature verification module 204 creates a digest on packaged data unit without digital signature and certificate, according to the method stated in digital signing method. Then the signature verification module 204 uses the selected suitable public key to decrypt the digital signature. If the decrypted signature is same as the digest, the data in packaged data unit is verified. If not, the data is not verified. The detail of signature verification process is defined in standards about digital signature of public key cryptography. In addition, before extracting public key from digital certificate, certificate must be verified by key manager module 205 according to the standards in public key infrastructure or PGP (pretty good privacy. If it is verified, the data archive module 203 extracts at least one text or binary data from data unit and returns them as the output. Otherwise, a warning signal will be shown to the user and ask for further action.

In some embodiments, if the key manager module 205 receives the digital certificate from the digital signature verification module 204 in Step 803, the key manager module 205 selects a suitable digital certificate according to the issuer identity in order to validate received digital certificate from barcode. After verification, the key manager module 204 may extract the public key from the received suitable digital certificate. And then the verification module 204 performs the verification as stated above.

Hereinafter, a system 2000 for creating and reading Authenticated document with Authenticated 2D barcode on it will be discussed.

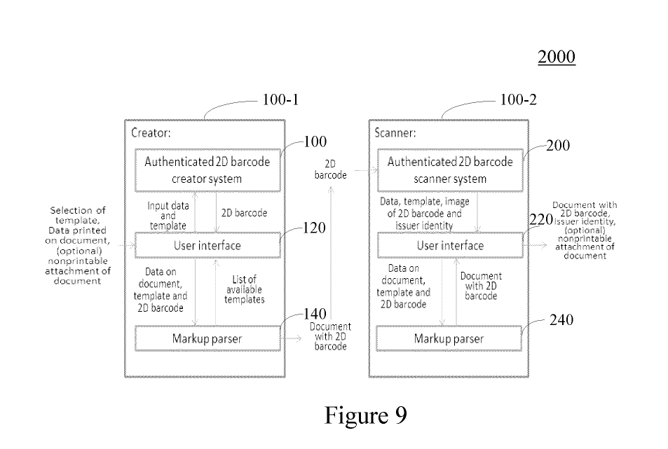

FIG. 9 illustrates the architecture of system of authentication and integrity checking on a printed document as well as data flow of this system. The system 2000 may comprise a document creator 100-1 and a document scanner 100-2. As shown in FIG. 9, the creator 100-1 comprises the apparatus 100 as discussed above, and a markup parser 140. The markup parser 140 may parse the document to get the template for the document for the user interface 120 to select. The document creator 100-1 may further comprises a user interface 120 configured to select a template of document, and, for each entry in template, except entry of Authenticated 2D barcode, the user fills in the responding data through the interface 120. User may also insert any data, including binary, as attachment through the interface 120. After data insertion, the user interface 120 passes all data, including template of document, to the barcode creator system (i.e. apparatus 100) to create a 2D barcode according to the user input with a selected private key, which is similar to the description in reference to FIG. 3. The 2D barcode(s) saves a digital copy of this document without barcode(s) entry. It also saves the optional attachments.

In particular, the 2D barcode may comprise all necessary data for the document including the layout of document. Accordingly, by scanning the barcode through the verification, a digital copy of the document as well as the data of the document issuer will be available. The User interface 120 then passes the generated barcode, template of document and a list of data that should be printed on the document to a markup parser 140. From all the received data, the markup parser 140 builds the output document. Data that is not part of document is saved inside barcode.

Referring to FIG. 9 again, the scanner 100-2 comprises the apparatus 200 as discussed above, a user interface 220 and a markup parser 240. The apparatus 200 scans the authenticated 2D barcode(s) on the document and verify the data as defined in authenticated 2D barcode. After verification, the barcode content, issuer identity, as well as image of barcode is sent to the user interface 220. The user interface 220 passes image of 2D barcode, template of document and entries on template to a markup parser 240 so that the markup parser 240 reconstructs a digital copy of document according to all the received data. The document, issuer identity, and other input data that is not part of document but saved in barcode, are shown to user.

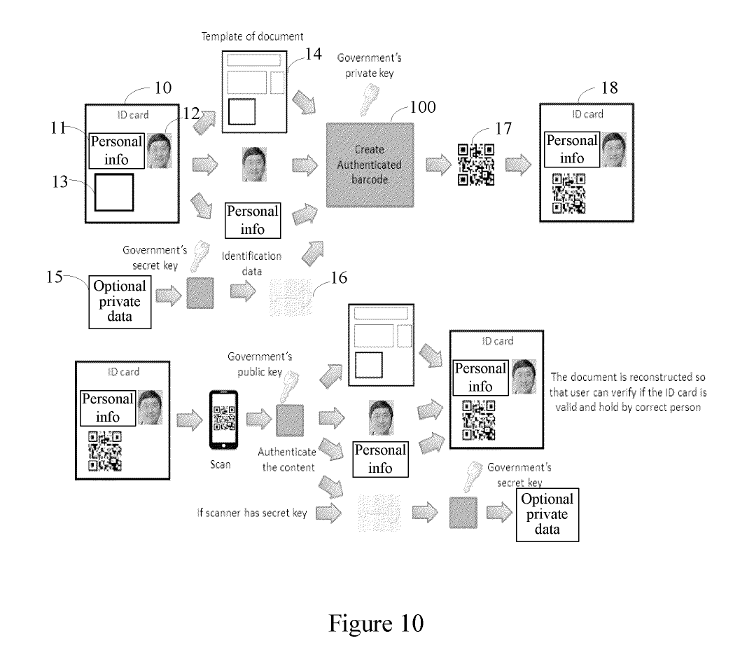

FIG. 10 illustrates the flow of document creation as well as barcode scanning according to some embodiments. Specifically, the document may refer to an ID card comprising the data entry for the name of document 10, the data entry for personal information 11, the data entry for personal image 12 and the black entry for the 2D barcode to be appended 13. The markup parser 140 parses the card to obtain the template of document 14. Then the user inputs the data for personal information like age, the address and so on, the data for personal image. Optionally, the user may also input some other biometric authentication data, such as finger print or the like, or other private data 15 that will not be printed on the document but shall be encrypted by the Government's secret key to generate an identification data 16. The user interface 120 then input the data 16 (if any), the personal information 11, the personal image 12 and the template of document 14 to the apparatus 100 to create a 2D barcode 17 that saves a digital copy of this ID card entries. The markup parser 140 attaches the created 2D barcode as well as the name of document 10, personal information 11 and data entry for personal image 12 to the template and create an ID card as shown in paper 18.

The apparatus 200 in the scanner 100-2 may scan the 2D barcode 17 attached to a physical ID card 18 to retrieve the content in the 2D barcode 17, and then verify the retrieved content by using a Government's public key. After verification, the apparatus 200 outputs data, template, image of 2D barcode and issue identity to the user interface 220. The user interface 220 may show the issue identity to the user. In addition, the markup parser 240 may reconstruct the document according to the contents of barcode. The issuer identity of barcode, the reconstructed document and other data in barcode are shown to user.

Authenticated document (Paper) as discussed above can be used whenever a document is needed to be checked. Documents like address proof, school transcript, ID card are applicable to this application. Besides the paper, Authenticated Paper also provides a mean to save and deliver digital data securely in hard copy. Three kinds of applications of the above discussed Authenticated document (Paper) may be used: 1) Low-cost certified document; 2) unforgeable low-cost identification; and 3) storage for digital data on printed medium, which will be discussed as below.

### 1) Low-Cost Certified Document

### 1.1 Example 1

### Notarized Copy of Document

Suppose a notary public wants to create a notarized copy of document from an applicant. He/she signs on the image of the document by his/her private key and creates an Authenticated Paper. The paper contains the image of the document, data about the notary public, time of issuing this copy and authenticated 2D barcode(s). The barcode on the notarized copy serves as certification signature, and contains a certified copy of the paper.

The digital certificate of notary public is also included on the paper as it is likely that the receiving company does not have the digital certificate of notary public to verify the message. The service provider in this case is governments of different countries. The notarized copy of document can be sent in multiple soft or hard copies without affecting the validity, as long as the 2D barcodes on the paper are still readable.

### 1.2 Example 2

### Immunization Record

An immunization may record contains history of all vaccinations a person received. This record greatly helps doctors in making diagnosis and treatments. In developing countries or distinct districts like Siberia, this record is written on paper. Paper record can be easily distorted under humidity, scratches, etc. If the vaccinations are injected from different organizations, the record may consists of many pieces of paper, which is difficult to be kept safely.

In this example, all data, including personal information, photo and history of vaccination, is saved inside 2D barcode(s) and signed by the organizations giving the vaccinations. The 2D barcode(s) are printed with the paper record. In some embodiments, the 2D barcode(s) may be printed on other surfaces like cloth or skin. When there is an update, the organization can read old record from original barcode and create updated one signed by them. At any time, there is only one piece of immunization record. Distortion on record can be recovered by error correction feature of 2D barcode(s).

### 1.3 Example 3

### Secure Check

After writing a check, the payer sticks an Authenticated 2D barcode on it. The barcode contains data on it and a photo/logo of payee. When the bank receives the check, it scans the barcode and gets a certified copy of the check. Hence, they can check whether it is modified and also whether the payee is original payee.

Digital certificate of the payer must be included as check receiving bank may not have the digital certificate of the payer.

Utilization of this application is not limited to the above mentioned examples 1-3. Any certified document, like address proof, can be implemented in this application. The 2D barcode(s) is used as a credential as well as a copy of the document.

This credential can also be printed on other medium such as cloth or skin as impermanent tattoo. The application models of Authenticated Paper also work on this application. Additional information of authenticated 2D barcode system also applies here.

### 2) Unforgeable Low-Cost Identification

### 2.1 Example 1

### Low-Cost Disposable ID Card

Suppose the writer is government and he wants to create ID card for a person. Some private data on ID card is confidential and should be known to designated scanners only. Government encrypts the private data by a secret key. The secret key has been transferred to the designated scanners. It inputs person's photo and identification data as entries of ID card and encrypted data as other data into creator system. The template of ID card is set in creator system.

All data is flown into creator system to create an ID card. The ID card shows the identification data and photo of the ID card holder and a QR code. The QR code is an authenticated 2D barcode containing all data.

The barcode(s) containing digital certificate is not printed on ID card as all scanner software should have the digital certificate of government.

Size of ID card is defined by template, which is designed by government. But the size of QR code on ID card must be large enough, such as 5 cm by 5 cm, for scanners to gets data from it.

When scanners scan the QR code on ID card, the content is authenticated as discussed in authenticated 2D barcode system. Template of ID card and photo and identification information of document holder are taken from barcode content. These data, as well as image of QR code, are used to construct a digital copy of the ID card in scanner. User of scanner uses this digital copy to authenticate the ID card they receive as well as the ID card holder. If scanner has the secret key, it will decrypt the encrypted content in QR code can get the private data.

### 2.2 Example 2

### Non-Transferable Ticket

When issuing a ticket, issuer creates Authenticated 2D barcode containing data on ticket and identification information of its owner like photo. The 2D barcode is printed with the ticket. Receivers get a copy of the ticket as well as identification information of ticket holder by scanning the 2D barcode. Hence they can validate both ticket and holder.

As owner identification is included, holders do not be afraid of document being stolen. However, transferring the ticket to others must involve the issuer.

### 2.3 Example 3

### Low-Cost Unforgeable Passport

Immigration department may create Authenticated Paper as the information page of a passport. The information page contains the information of passport holder, as well as Authenticated 2D barcode containing the data of information page digitally signed by government. When other authorities scan the 2D barcode and get a certified digital copy of the passport information page. Then they can use it to authenticate the information page of passport. As the data is signed, it is unforgeable.

Utilization of this application is not limited to those examples as discussed in 2.1-2.3. For Low-cost disposable ID card, it can works as any identification document like student ID, staff card in a company. Non-transferable ticket can work on train ticket, airplane ticket, event pass, etc. Besides ticket, this application also works as coupon or membership card for customer loyalty program across groups of companies, as only issuer can create valid ticket while other companies can verify it. Suppose a company wants to offer discount to the members in other companies, it just needs to have the digital certificate of those companies and it can authenticate the members. No application for special hardware or access to issuer's database is necessary. There is no change on the membership cards or database in those companies and no privacy data is needed to be passed to discount offering company.

Low-cost unforgeable passport also works on immigration related document like passport stamp and visa.

Any 2D barcode can be used in this application, no limited to QR code only. The application models of Authenticated Paper also work on this application. Additional information of authenticated 2D barcode system also applies here.

### 3) Storage for Digital Data on Printed Medium

This system is essentially Authenticated Paper system. But the focus is on the data inside the barcode(s). The printed content only serves as metadata to the content of the barcode(s).

Suppose a user wants to save a secret song file on paper. He/she inputs the song file into creator of this system. The encryption unit in creator creates an AES 256 bits secret key to encrypt the song file. The secret key is then encrypted by public key in digital certificate of user and then appended with the encrypted song file. The public key follows the preferred embodiment of Authenticated Paper.

This encrypted data replace the original song file as data input and an authenticated 2D barcode is created following the preferred embodiment of authenticated 2D barcode. The created barcode is an encrypted and authenticated copy of the song. Metadata of the song, time of creation and the barcode are printed as a document.

When the user wants to read the song from barcode later, he/she uses the scanner of this system to scan the barcode. After authentication checking following the preferred embodiment of Authenticated Paper system, the data is passed to decryption unit for decryption. Decryption unit first decrypts the secret key from data using user's private key, then uses the secret key to decrypt the song and returns the song as system output.

From structure point of view, this system is very similar to Authenticated Paper system. But the digital signature generation unit in authenticated 2D barcode creator unit in the creator of this system and digital signature verification unit in authenticated 2D barcode scanning unit in scanner of this system are replaced by encryption unit and decryption unit, respectively.

Encryption/decryption unit supports features of digital signature generation/verification unit as well as symmetric key data encryption/decryption. From structure point of view, encryption unit has four parts: digital signing unit, key manager, encrypting unit and key generation unit.

Digital signing unit and key manager are same as those in digital signature generation unit in authenticated 2D barcode creator.

Encryption unit runs symmetric key encryption on data. Key generation unit creates secret key for data encryption.

In preferred embodiment, the encryption follows standard in Advanced Encryption Standard (AES) and secret keys generated are AES 256 bits keys. Decryption unit has the components in digital signature verification unit as well as a decryption unit to decrypt data by symmetric key.

As long as both creator and scanner supports, any symmetric key cryptography can be applied on this application. Any binary data can be saved in barcode. Key length of the keys in this system may be varied.

In preferred embodiment, the data in barcode can be read by writer of document only. However, they can use the public key of other user to encrypt the secret key. Then the data in barcode can be read by that user only. In this setting, it allows creator to send confidential data to others via barcode. Creator may disable the features of confidentiality or authentication by disabling the data encryption part or digital signature generation part of the system respectively. But scanner should show a warning to user when skipping the related test(s) when scanning such barcodes.

It shall be understood that the above mentioned examples shall be based on a service model. For ease of understanding, the service model of Authenticated Paper under different situations will be discussed hereinafter.

In a sample service model, there are third parties. The writer (one user) operates the creator to create an Authenticated Paper using private key of his/her private-public key pair. Reader (another user) uses the scanner to scan the 2D barcode(s) on Authenticated Paper to get verified copy of the document and use it to authenticate the printed content on Authenticated Paper. To check the data in the barcode, the reader needs to have a digital certificate of the writer. The digital certificate should be issued by a trustworthy party so that the reader is willing to accept it. This party is the service provider.

Given that there is only one service provider, the writer can request the key pair and the digital certificate from a third-party certificate authority. They can also prepare the key pair themselves using the prior standards and apply for the digital certificate from service provider.

If there is no third-party service provider, or the writer itself is also the service provider, the key pairs and the digital certificate are prepared by writer.

Besides using the creator to create the Authenticated Paper, the writer may apply one from the service provider by applying an account and then submit all necessary information to the service provider. In this case, the key pairs and the digital certificate for the writer are created and saved by the service provider.

There are three ways for the scanner to get the digital certificate: 1) the scanner gets it from the barcode the containing digital certificate, 2) the scanner gets it from trusted source though internet; 3) the digital certificate is saved in the scanner before delivery.

This present application also includes how to distribute the digital certificate though the barcode. The digital certificate is saved in the data unit with dedicated entry. The data unit may contain data in data entry. If there is no data entry, the format header of the data unit will indicate that the data unit is used to distribute digital certificate. The data unit is saved in barcode(s) as described in authenticated 2D barcode.

If the digital certificate is gotten though internet, the scanner will only send a request to the service providers listed inside the scanner system. It will send the request to trust source for the digital certificate according to the identity of the barcode scanned. If no suitable certificate is returned, the barcode content is considered as not authenticated and the user is asked for further actions. If there is no service provider in scanner, or barcode scanned is issued by the service provider that scanner does not have suitable certificate to authenticate, a warning will be posted to the user for further actions. The scanner may also send the request to the service providers regularly to get a list of trusted digital certificates and revoked certificates.

In some embodiments, the service provider may give the job of delivering creator and scanner as software to other parties, given that the software will contact service provider for any digital certificate related issue.

The embodiments of the present invention may be implemented using certain hardware, software, or a combination thereof. In addition, the embodiments of the present invention may be adapted to a computer program product embodied on one or more computer readable storage media (comprising but not limited to disk storage, CD-ROM, optical memory and the like) containing computer program codes.

In the foregoing descriptions, various aspects, steps, or components are grouped together in a single embodiment for purposes of illustrations. The disclosure is not to be interpreted as requiring all of the disclosed variations for the claimed subject matter. The following claims are incorporated into this Description of the Exemplary Embodiments, with each claim standing on its own as a separate embodiment of the disclosure.

Moreover, it will be apparent to those skilled in the art from consideration of the specification and practice of the present disclosure that various modifications and variations can be made to the disclosed systems and methods without departing from the scope of the disclosure, as claimed. Thus, it is intended that the specification and examples be considered as exemplary only, with a true scope of the present disclosure being indicated by the following claims and their equivalents.

What is claimed is:

1. A computer-complemented method for generating a 2D barcode, comprising:
retrieving a predetermined private key, a predetermined digital signature method and an issuer identity of a 2D barcode;
generating a signature for at least one data with the retrieved private key in accordance with the retrieved digital signature method;
inserting the at least one printable data together with the generated signature and the retrieved issuer identity into a self-contained data unit; and
creating a barcode image containing the self-contained data unit.

2. The method according to claim 1, wherein the retrieving further comprises:
obtaining the issuer identity of the 2D barcode; and
retrieving the private key and the digital signature method according to the obtained issuer identity.

3. The method according to claim 1, wherein the creating further comprises:
compressing the self-contained data unit with the inserted signature; and
creating the 2D barcode with the compressed data unit.

4. The method according to claim 1, further comprising:
predetermining a private-public key pair, the pair at least comprising said private key;
applying for a digital certificate from a service provider, wherein the digital signature method is enclosed in the applied digital certificate; and
associating the private key and the digital signature method with the issuer identity.

5. The method according to claim 1, wherein the creating further comprises:
applying a digital certificate to the self-contained data unit; and
creating the 2D barcode with the self-contained data unit applied with the digital certificate.

6. The method according to claim 1, wherein the at least one data comprises one selected from a group consisting of at least one printable text or binary data, a digitally-signed device-driver-code, a self-describing programming interface, and a self-describing service-access interface.

7. A computer-complemented method for verifying a 2D barcode, comprising:
extracting a packaged data unit from the barcode;
retrieving, from the extracted data unit, a copy of packaged data without a digital signature and a certificate, a digital signature, an issuer identity of the barcode, and a digital signing method;
creating a digest on the packaged data unit according to the retrieved digital signing method;
selecting a suitable digital certificate associated with the retrieved issuer identity, the suitable digital certificate including a public key for verifying the barcode;
decrypting the retrieved digital signature with the selected suitable public key; and
determining if the decrypted signature is the same as the digest, and, if yes, verifying the data in the packaged data unit.

8. The method according to claim 7, wherein, the data comprises one selected from a group consisting of at least one printable text or binary data, a digitally-signed device-driver-code, a self-describing programming interface, and a self-describing service-access interface.

9. The method according to claim 7, wherein the determining further comprises showing at least the issuer identity to a user.

10. A computer-complemented method for creating a document with authentication features, comprising:
obtaining a layout of a document template with a plurality of data entries, wherein a first data entry is used for a 2D barcode;
inputting at least one data corresponding to the data entries;
creating, with a private key, a digital signature; and
forming the 2D barcode with the created digital signature, wherein the created 2D barcode further includes the layout of the document template and the inputted at least one data.

11. The method according to claim 10, further comprising:
inputting at least one private data for a user; and
applying a predetermined secret key to the private data to encrypt the data,
wherein the creating further comprises: packetizing the encrypted data into the 2D barcode.

12. The method according to claim 11, wherein the data entries are text or image data that is printable.

13. The method according to claim 11, further comprising obtaining biometric authentication data, and wherein the creating further comprises packetizing the biometric authentication data into the 2D barcode.

14. A computer-complemented method for reading a document, comprising:
scanning a 2D barcode appended in the document to extract a digital signature, an issuer identity of the 2D barcode and at least one data, a digital signing method, and a document template;
selecting a public key according to the extracted issuer identity;
verifying at least one data with the selected public key and extracted digital signature in accordance with the retrieved digital signing method;
retrieving the extracted template of document and the data entries; and
reconstructing a new document according to the extracted document template and at least one data.

15. The method according to claim 11, further comprising showing the reconstructed document and the issuer identity to a user.

16. Apparatus for creating a document with a 2D barcode, comprising:
A not-transitory computer-readable storage medium for storing executable computer program modules comprising:
a key manager module configured to prepare an issuer identity of the barcode, and to retrieve a private key and digital signature method according to the issuer identity;
a data archive module configured to insert at least one printable data and the prepared issuer identity into a self-contained data unit;
a digital signature generation module configured to generate a signature with the retrieved private key in accordance with the retrieved digital signature method, wherein the data archive module inserts the generated signature into the self-contained data unit;
a barcode generation module configured to create a barcode image containing the self-contained data unit after digital signature is inserted, and
a processor configured to execute the computer program modules.

17. Apparatus for verifying a document with a 2D barcode, comprising:
a not-transitory computer-readable storage medium for storing executable computer program modules comprising:
a barcode scanning module configured to read contents of a barcode;
a data archive module configured to retrieve a copy of packaged data without the digital signature and the certificate, a digital signature, an issuer identity of the barcode, a digital signing method from the extracted data unit;
a key manager module configured to select, according to the issuer identity, a suitable digital certificate including a public key for verifying the barcode;
a digital signature verification module configured to create a digest on the packaged data unit according to the digital signing method, decrypt the digital signature with the selected suitable public key, and determine if the decrypted signature is same as the digest, and, if yes, verifying the data in the packaged data unit; and
a processor configured to execute the computer program modules.
